(19) United States
(12) Patent Application Publication
(10) Pub. No.: US 2026/0306350 A1
(43) Pub. Date: Oct. 8, 2026

(54) MASSAGING APPARATUS WITH POSITIVE LOCK FOR INTERCHANGEABLE MASSAGING ACCESSORY

(71) Applicant: LifePro Fitness LLC, Staten Island, NY (US)

(72) Inventor: Joel Gottehrer, Staten Island, NY (US)

(21) Appl. No.: 19/098,990

(22) Filed: Apr. 3, 2025

(51) Int. Cl. A61H 23/00; A61H 23/02

(52) U.S. Cl. CPC A61H 23/006; A61H 23/02; A61H 2201/0153; A61H 2201/0157; A61H 2201/1207; A61H 2201/1664; A61H 2201/1685

(57) ABSTRACT

A massaging gun or tool comprises a housing, the housing having an open end and an impact/reciprocation assembly disposed within the housing and secured thereto. The impact assembly comprises a reciprocating rod with adjustable travel and impact force. An impelling means is provided to accelerate the reciprocating rod. Disposed on one end of the reciprocating rod is a coupler to permit multiple impact/massaging heads to be interchangeably attached to the tool. The coupler within the tool and the massaging heads are provided with complementary detent and groove structure to enable the heads to be positively secured to each other, to avoid risk of the head shooting away from the tool body during use.

### BACKGROUND OF THE INVENTION

The present invention involves the field of medical and post workout recovery devices, including massaging devices and more particularly percussive therapy devices that provide reciprocating motion. Devices of the invention involve the field of percussive devices used for post workout recovery muscle massaging and as chiropractic adjustment tools used to move bones and relieve muscle spasms and stress.

As noted above, in addition of being widely used for post workout recovery of aching muscles, percussion is also a treatment modality for those who suffer from musculoskeletal pain and myofascial trigger syndrome. It is a non-surgical, non-invasive procedure that may serve as a therapeutic alternative to trigger point and epidural injections or be used when other treatments have failed. Performed on an outpatient basis, percussive treatment carries little or no risk and is relatively comfortable.

As is well-known in the chiropractic art, the spines or other bones of humans sometimes go out of alignment or are otherwise misadjusted. This can lead to discomfort and additional physical symptoms. In such cases an adjustment of the spine or other bone to a healthy alignment can have substantial therapeutic effects.

One of the aspects of the percussive devices of the type addressed herein involves the desire to provide a plurality of easily exchangeable treatment or impact heads that could be quickly interchanged by the professional administering treatment and/or by those who use the devices themselves. It is important to assure that these treatment heads are very solidly secured to the massaging implement without concern of the head falling or shooting out while reciprocating at high speed.

### SUMMARY OF THE INVENTION

Accordingly, it is an object of the present disclosure to provide a massaging tool having improved means for securely retaining the treatment heads to the body of the massaging tool even when the treatment head reciprocates at very high speeds.

The foregoing and other objects of the present disclosure are attained, in accordance with preferred embodiments, by a massaging tool, the tool comprising: a tool housing, said housing including a hand grip and a main body portion supporting therein a reciprocation assembly that produces reciprocal motion; a treatment-head sleeve supported by the main body portion and mechanically coupled to the reciprocation assembly to move reciprocally relative to the housing; an treatment head connected to and within said sleeve in a manner that imparts to the treatment head said reciprocal motion, the treatment head including a treatment portion and a support stem attached thereto; and a head-to-sleeve coupling structure including a catch formed on an interior surface of sleeve and first and second grooves formed on the stem of the treatment head, so formed that the first groove is sized to slide over and beyond the catch to enable the treatment head to be rotated so as to cause the catch to be received within the second groove thereby firmly affixing and mechanically interconnecting the treatment head to the sleeve, while enabling removal thereof through counter-rotation of the treatment head, thereby permitting quick interchanging of differently shaped treatment heads.

In preferred embodiments, said housing includes a head holding part and said sleeve is supported by and reciprocally movable within said head holding part and said head holing part including a marking on an outer surface thereof which enables rotationally aligning the stem of the treatment head to allow its insertion into the sleeve. Preferably, an outer surface of the catch is ridged and a corresponding bottom surface of the second groove is ridged to increase a frictional holding force of the catch and groove to each other.

Preferably, the sleeve is provided with another catch of as same shape and size and located diametrically opposed to said catch, and said stem is provided with another set of first and second grooves located diametrically opposed to said first and second grooves. The massaging tool may be provided with a plurality of additional treatment heads, each of which comprises a treatment portion that is differently shaped from corresponding treatment portions present in all other treatment heads. A power source located in the hand grip, e.g., a battery, provides electrical power to said reciprocation assembly.

For a more complete understanding of the present invention, reference is made to the following detailed description and accompanying drawings. In the drawings, reference numbers refer to like parts through the several views.

### BRIEF DESCRIPTION OF THE DRAWINGS

FIG. 1 diagrammatically depicts a prior art massager with three different and interchangeable impacting heads.

FIG. 2 is a cutaway view of the impact tool of FIG. 1.

FIG. 3 is a detail of the spring pair assembly of FIG. 2.

FIG. 4 depicts the known technique of using a generic prior art massaging/impacting tool, enabling a health professional to treat the neck area of a patient.

FIG. 4A depicts a sampling of the many known shapes of treatment head.

FIG. 5 depicts a massage gun/tool using the head mounting technique of the present invention including a marking line on the tool body to help guide the treatment head into the receiving port of the tool.

FIG. 6 depicts the massaging tool of FIG. 5 with the treatment head separated from the tool.

FIG. 7 is a top view of FIG. 5.

FIG. 8 depicts connection components provided on the treatment tool for easy and secure connection to the tool.

FIG. 9 depicts an internally provided receiving sleeve in the tool for firmly holding the treatment head.

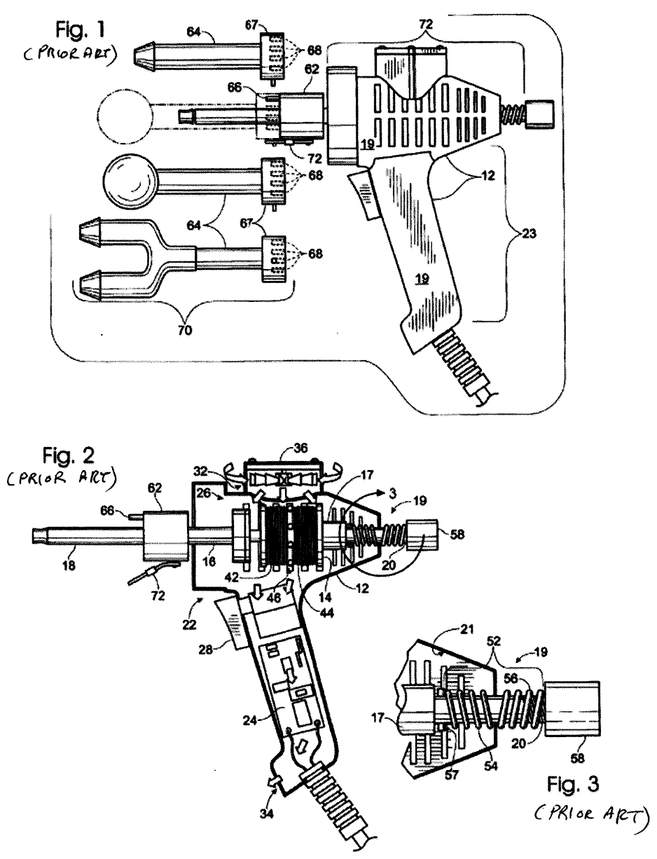

### DETAILED DESCRIPTION OF EMBODIMENTS OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Initially, reference is made to the generic massaging tool 10 that is depicted and described in U.S. Patent Publication No. 2003/0195443 (“the '443 Publication”), the contents of which are incorporated by reference herein, for the purpose of describing a generic treatment tool of the type to which the present invention is applicable. Referring to the drawings of the '443 Publication, there is depicted a chiropractic adjustment tool or tapper generally denoted at 10. The tapper 10, generally, comprises a housing 12, an impact assembly 26 disposed within the housing, the impact assembly 26 comprising a motive source 14, preferably a solenoid 14, the motive source 14 providing operational power to the impact assembly 26 and a reciprocating rod 16 with an impact head 70 disposed at one end and secured to the reciprocating rod 16 by a coupler. At one end of the housing is an import 32 to permit air flow, and at a distal end, an out port 34 so positioned to permit air flow to transit the elements of the tool needing cooling such as the solenoid 14, switches 28 and any circuitry 24. A fan 36 is provided to increase airflow.

The housing 12 is a hollow member having an outer surface 19 and an inner surface 21. The housing 12 is made of any convenient material, such as plastic, metal, or the like. The housing 12 has a handle portion 23 to enable easy grasping and holding of the tapper 10. The housing 12 also has a barrel portion 22 integral with the handle portion 23.

Contained in the barrel portion 22 and affixed thereto is the motive source 14, which in the preferred embodiment is a solenoid 14. An improvement in the present invention is the use of a solenoid 14 with at least two coil elements comprising a first coil 42, and a second coil 44 separated by an airspace 46 to permit improved cooling.

Transiting through the solenoid 14 is a reciprocating rod 16 responsive to the force generated by the solenoid 14 such that on activation the reciprocating rod 16 is accelerated axially.

An electric energy source is operatively connected to a switch 28, preferably mounted in the handle portion 23. The switch 28 is operatively connected to the solenoid 14 so that on activation, the solenoid 14 receives power. The switch 28 may be in any well-known form, including a “trigger” or a “button,” either of which plungingly closes the circuit to the power source. In the preferred embodiment, the circuit also contains additional circuitry 24 such as a relay or similar device to automatically activate and deactivate the solenoid 14 at an adjustable rate.

The reciprocating rod 16 is axially elongated and has a forward first end 18 on which is mounted a coupler 62, a medial portion 17 defined by an enlarged diameter portion which receives the motive force from the solenoid 14, and a rearward second end 20 which is preferably threaded. The reciprocating rod 16 transits the barrel portion of the housing and the solenoid 14 contained therein. The reciprocating rod 16 exits two distal ends of the barrel portion of the housing. A coil spring pair 52, placed in series, is disposed around the rearward end 20 of the reciprocating rod 16 with a forward spring 54 and a rearward spring 56.

The rearward spring 56 is of a heavier gauge than the forward spring 54. The forward spring 54 is disposed around the reciprocating rod 16 and held in place by an adjustable stop 57 placed in the reciprocating rod 16 on the forward end of the forward spring 54 and is biased against the inner surface of the housing 21 on the rearward end of the forward spring 54. The rearward spring 56 disposed around the reciprocating rod 16 is biased against the outer surface of the housing 19 and fitted against a threaded annular head 58.

The threaded annular head 58 is rotatably threaded onto the rearward end 20 of the reciprocating rod 16. In operation the travel and force of the reciprocating rod 16 may be adjusted by tightening the annular head 58 and compressing the spring pair 52. As the rearward spring 56 in the spring pair is heavier than the forward spring 54 of the spring pair, the forward spring 54 is compressed at a greater rate than the rearward spring 56, causing the reciprocating rod 16 to draw back or be displaced towards the rear of the housing. The increased compression of the spring pair 52 and displacement of the reciprocating rod 16 adjusts axial travel of the reciprocating rod 16 when the solenoid 14 is activated. The spring pair 52 also provides the neutral position of the reciprocating rod 16 when not being impelled or accelerated by the solenoid 14, such that on deactivation of the solenoid 14, the reciprocating rod 16 recoils and returns to the neutral position as determined by the spring pair 52. This provides the additional benefit of permitting the impact head 70 to impart force on the patient being treated without pressure of any duration.

The adjustable stop 57 and the annular head 58 are marked with indicators to permit calibrated adjustments to the compression of the individual springs 54, 56, in the spring pair 52. This may be accomplished by moving the stop 57 to alter the compression of the forward spring 54 against the inner surface of the housing 21 independent of the adjustments of the annular head 58 which principally adjusts the compression of the rearward spring 56. This permits added control over the force imparted by the impact head 70 on the patient, and also permits adjustment of the movement of the reciprocating rod 16, slowing or adjusting the acceleration rate.

In use, the impact head 70 makes contact and imparts force only briefly on activation of the solenoid 14, and then is immediately withdrawn and returned to the neutral position by the spring par 52. The use of a solenoid 14 or similarly driven system permits the imparting of therapeutic force without any extended pressure. The benefit of the invention is obtained by the acceleration of the reciprocating rod 16, and then permitting the reciprocating rod 16 to bounce or recoil on impact of the impact head 70 with the patient without any persistent pressure on the patient. In the preferred embodiment, acceleration is complete prior to impact. Extended pressure of any duration increases the likelihood of bruising. Avoiding extended pressure also permits higher levels of impact to be used without causing the patient pain.

When the power source 22 is engaged via the switch 28, the solenoid 14 impels the reciprocating rod 16 forward to impact the patient. When the solenoid 14 is turned off or deactivated, the reciprocating rod 16 returns to the neutral position as determined by the spring pair 52. The device may be set to provide for a single impact in activation, or with the use of a relay or similar circuitry 24, a rate of impact may be established and adjusted by sequentially activating and deactivating the solenoid 14 once the power source is engaged. The switch 28 may be variable such that rate of impact increases with pressure on the switch 28, or a second switch or dial (not shown) may be used to adjust the rate of impact. Such second switch may be located at the point of the out port 34 or another convenient location.

Affixed to the forward end 18 of the reciprocating rod 16 is a coupler 62. The coupler 62 is used for affixing impact heads 70 of varying shapes. In the preferred embodiment the coupler 62 is formed so as to permit the impact head 70 to be removably affixed to the reciprocating rod 16 at a set, but adjustable angle. This is accomplished through the use of a sleeve element 64 on the impact head 70. The coupler is comprised of a collar 62 affixed to the reciprocating rod 16, a collar pin 66 set on the collar 62 and pin notches 68 set in a sleeve base 67 of the sleeve element 64. The collar 62 is mounted on the reciprocating rod 16 offset from the forward end 18 so as to permit the sleeve element 64 of the impact head to receive a portion of the forward end 18 of the reciprocating rod 16 for stability. The sleeve base 67 abuts the collar 67 and the collar pin 66 is received into one of a number of defined pin notches 68 on the sleeve base 67 so as to prevent rotation of the impact head 70. A simple retaining hook or loop 72 or similar means retains the impact head 70.

Depending on the positioning of the annular ring 58 on the reciprocating rod 16, and the relative compression of the spring pair 52, the reciprocating rod 16 is driven forward and forces one of the impact heads 70 mounted thereon to contact the person being treated at any of a range of rates, travels and force levels. The single or continuous series of impacts provides therapeutic treatment to the person being treated.

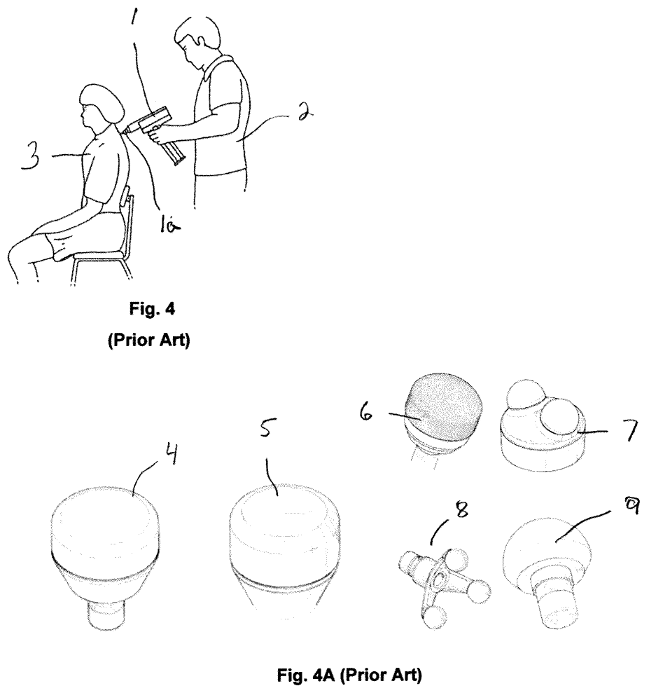

Referring to prior art FIGS. 4 and 4A, the generic massaging tool 1 having the massaging head 1a is typically used by a treatment professional 2 holding the tool by its handle and administering massaging therapy to a patient 3, at the neck area and/or to other parts of the patient's body. As to the specific shapes of the head interchangeably connected to the body of the tool 1, FIG. 4A shows various forms thereof including the form of the heads 4, 5, 6, 7, 8 and 9, while recognizing the shape variations can take on many other shapes not illustrated here but well known in the art.

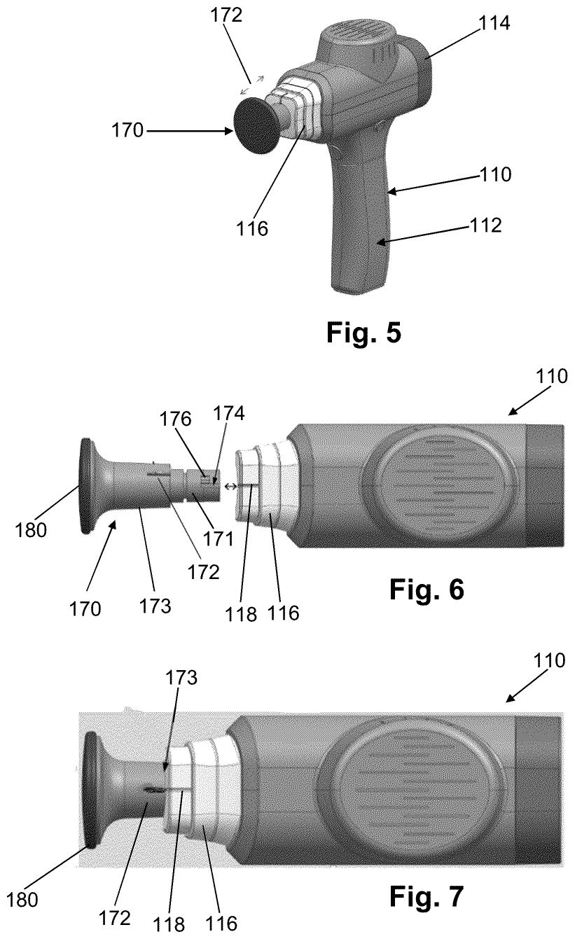

For the purposes of the specific inventions herein, reference is now drawn to FIGS. 5 through 9 for explicating the novel head-to-tool coupling structure that anchors the present invention. Thus, in FIG. 5, the massaging tool 110 has a gripping handle 112 (also holding a battery, not shown), a main body 114 in which are housed the motor and reciprocation motion mechanisms (not shown but which may use described in the '443 Publication) and a head holding part 116, removably supporting the reciprocating head 170 (as indicated by the dual arrow 172).

As shown in FIG. 6, the head holding part 116 includes an alignment, linear mark 118 that serves to allow easy aligning of the head 170 during insertion into the part 116, as will be shortly shown.

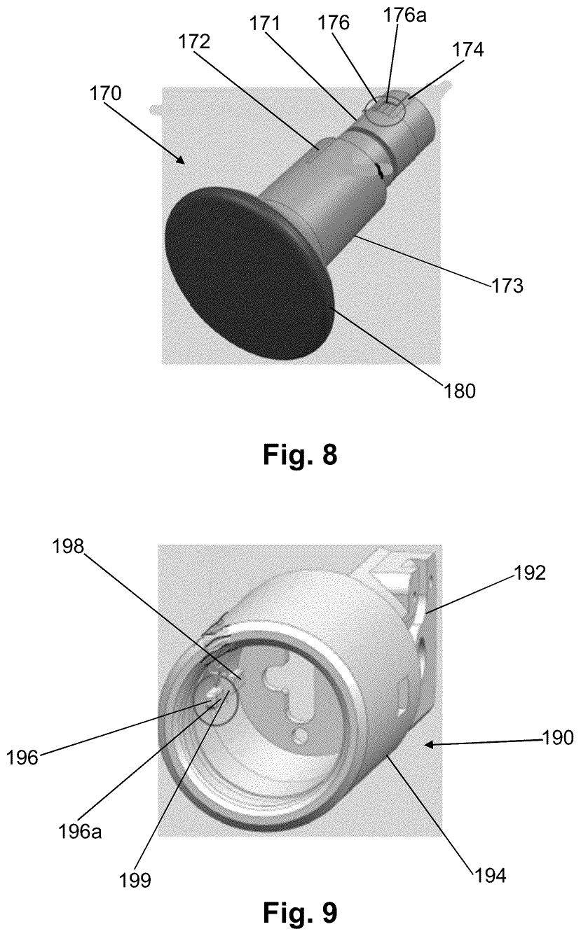

The massaging head 170 has an insertable portion, e.g. a stem, that is fully receivable in the holding part 116, a main body 173 and a patient contacting part or head 180 that is shaped to contact the patient. As best seen in FIG. 8, the insertable part 171 is formed to including a comparatively narrow, linear groove 174 that leads into a wider groove 176 having surface ridges 176a therein. Note the marking line 172 provided on the body 173 for being orientated in line with relative to the groove 174, during insertion of the head 170.

Turning to FIG. 9, the mounting sleeve 190 is located inside the head holding part 116 of the tool 170, and has an engaging part 190 configured to interconnect with reciprocation means (not shown, but functionally similar to what is shown in FIG. 2) inside the tool 170 to receive reciprocation motion from the motor within, which is then imparted to the cylindrically shaped part 194 of the sleeve 194 and in turn to the head 170 when inserted therein. To hold onto the head 170, on the circular interior surface of the part 194 is formed with a head catch 194 that is followed by a head stop with a separation therebetween. The top surface 194a of the head catch 194 is ridged, to create friction and to interact with the similarly ridged surface 176a of the groove 176.

To secure the head 170 to the tool 110, the groove 174 is aligned with the mark 118 on the holder 116. This permits the head 170 to slide into the interior of the sleeve 194, while sliding over the catch 196. When the distal end of the part 171 strikes/abuts the stop 199, the head 170 is capable of being rotated clockwise, which causes the catch to slide into wide groove 176, thereby locking the head 170 to the tool 110. The inter-connectable catch and groove system forms a secure coupling structure between the head and the sleeve that prevents accidental separation thereof while they reciprocate at high speed.

The components 174/176 on the head 170 and the components 196/198 inside the sleeve 194 can be duplicated in a position diametrically opposite to where shown, thereby interlocking the head to the sleeve on two, diametrically opposite locations. The aforementioned ridges 176a/194a interact/interlock, so that in the normal course of use of the tool 110 the head and the sleeve do not disengaged from each other.

While the invention has been illustrated and described in detail in the drawings and the foregoing description, the same is to be considered as illustrative and not restrictive in character, it being understood that only the preferred embodiment has been shown and described fully and that all changes and modifications that come within the spirit of the invention are desired to be protected.

What is claimed is:

1. A massaging tool, the tool comprising:
a tool housing, said housing including a hand grip and a main body portion supporting therein a reciprocation assembly that produces reciprocal motion;
a treatment-head sleeve supported by the main body portion and mechanically coupled to the reciprocation assembly to move reciprocally relative to the housing;
an treatment head connected to and within said sleeve in a manner that imparts to the treatment head said reciprocal motion, the treatment head including a treatment portion and a support stem attached thereto; and
a head-to-sleeve coupling structure including a catch formed on an interior surface of sleeve and first and second grooves formed on the stem of the treatment head, so formed that the first groove is sized to slide over and beyond the catch to enable the treatment head to be rotated so as to cause the catch to be received within the second groove thereby firmly affixing and mechanically interconnecting the treatment head to the sleeve, while enabling removal thereof through counter-rotation of the treatment head, thereby permitting quick interchanging of differently shaped treatment heads.

2. The massaging tool of claim 1, wherein said housing includes head holding part and said sleeve is supported by and reciprocally movable within said head holding part and said head holding part including a marking on an outer surface thereof which enables rotationally aligning the stem of the treatment head to allow its insertion into the sleeve.

3. The massaging tool of claim 2, wherein an outer surface of the catch is ridged and a corresponding bottom surface of the second groove is ridged to increase a frictional holding force of the catch and groove to each other.

4. The massaging tool of claim 1, wherein the sleeve is provided with another catch of a same shape and size and located diametrically opposed to said catch, and said stem is provided with another set of first and second grooves located diametrically opposed to said first and second grooves.

5. The massaging tool of claim 1, including a plurality of additional treatment heads, each of which comprises a treatment portion that is differently shaped from corresponding treatment portions present in all other treatment heads.

6. The massaging tool of claim 1, including a power source located in the hand grip for providing electrical power to said reciprocation assembly.
